(19) United States
(12) Patent Application Publication
(10) Pub. No.: US 2026/0068954 A1
(43) Pub. Date: Mar. 12, 2026

(54) AEROSOL-GENERATING DEVICE AND METHOD OF CONTROLLING THE SAME

(71) Applicant: KT&G CORPORATION, Daejeon (KR)

(72) Inventor: Jin Chul JUNG, Daejeon (KR)

(73) Assignee: KT&G CORPORATION, Daejeon (KR)

(21) Appl. No.: 19/256,610

(22) Filed: Jul. 1, 2025

(30) Foreign Application Priority Data
Sep. 9, 2024 (KR) 10-2024-0122716

(51) Int. Cl. A24F 40/57; A24F 40/20; A24F 40/465; H05B 6/10

(52) U.S. Cl. CPC A24F 40/57; A24F 40/20; A24F 40/465; H05B 6/108

(57) ABSTRACT

Provided is an aerosol-generating device including a heater assembly including a heater disposed around at least a portion of a cigarette inserted into the aerosol-generating device, a heating circuit connected to the heater, and a processor configured to control a signal supplied to the heater through the heating circuit. The processor is configured to generate a first signal having a first frequency using the heating circuit, supply the first signal to the heater, determine a current state of the aerosol-generating device, generate a second signal having a second frequency using the heating circuit when the current state corresponds to a target state, and supply the second signal to the heater.

### CROSS-REFERENCE TO RELATED APPLICATION

This application claims the benefit of Korean Patent Application No. 10-2024-0122716 filed on September 9, 2024, in the Korean Intellectual Property Office, the entire disclosure of which is incorporated herein by reference for all purposes.

### BACKGROUND

### Field of the Invention

One or more embodiments relate to an aerosol-generating device and a method of controlling the same, and more particularly, to an aerosol-generating device for controlling a signal supplied to a heater that heats a cigarette inserted into the aerosol-generating device and a method of controlling the same.

### Description of the Related Art

The demand for electronic cigarettes, or e-cigarettes, has recently been on the rise. The rising demand for electronic cigarette devices has accelerated the continued development of electronic cigarette device-related functions. The electronic cigarette device-related functions may include, in particular, functions according to the types and characteristics of electronic cigarette devices, and functions for improving effectiveness of the electronic cigarette device.

In a case of a heater configuring the electronic cigarette device, as the temperature increases, the resistance also increases, which reduces the performance of the heater. In order to solve the above problem, a method of increasing current by increasing a voltage supplied to the heater, or minimizing initial resistance is used. However, even in these cases, problems such as circuit complexity or increased initial inrush current may occur. There is a need to provide a method of controlling an electronic cigarette device that simplifies the circuit while minimizing voltage drop.

### SUMMARY

The present disclosure is provided to solve the above-mentioned problems and other problems.

One embodiment may provide an aerosol-generating device for changing an operating frequency of a signal provided to a heater and a method of controlling the same.

One embodiment may provide an aerosol-generating device for controlling a heater based on different frequencies and method of controlling the same.

However, the technical aspects are not limited to the aforementioned aspects, and other technical aspects may be present.

According to an aspect, there is provided an aerosol-generating device including a heater assembly including a heater disposed around at least a portion of a cigarette inserted into the aerosol-generating device, a heating circuit connected to the heater, and a processor configured to control a signal supplied to the heater through the heating circuit, wherein the processor is configured to generate a first signal having a first frequency using the heating circuit, supply the first signal to the heater, determine a current state of the aerosol-generating device, generate a second signal having a second frequency using the heating circuit when the current state corresponds to a target state, and supply the second signal to the heater.

According to another aspect, there is provided a method of controlling an aerosol-generating device performed by the aerosol-generating device, wherein the aerosol-generating device includes a heater assembly including a heater disposed around at least a portion of a cigarette inserted into the aerosol-generating device, a heating circuit connected to the heater, and a processor configured to control a signal supplied to the heater through the heating circuit, and the method includes generating a first signal having a first frequency using the heating circuit, supplying the first signal to the heater, determining a current state of the aerosol-generating device, generating a second signal having a second frequency using the heating circuit when the current state corresponds to a target state, and supplying the second signal to the heater.

Additional aspects of embodiments will be set forth in part in the description which follows and, in part, will be apparent from the description, or may be learned by practice of the disclosure.

According to embodiments, an operating frequency of a signal provided to a heater may be changed.

According to embodiments, it may be possible to provide an aerosol-generating device for minimizing voltage drop while simplifying a circuit by changing an operating frequency of a signal provided to a heater, and a method of controlling the same.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a block diagram of an aerosol-generating device according to an embodiment;

FIG. 2 illustrates an aerosol-generating device according to an embodiment;

FIG. 3 is an exploded view of a heater assembly according to an embodiment;

FIGS. 4A and 4B are exploded cross-sectional views of a removable heater assembly according to an embodiment;

FIGS. 5A and 5B are exploded cross-sectional views of an integrally formed heater assembly according to an embodiment;

FIG. 6 illustrates a configuration of an aerosol-generating device according to an embodiment;

FIG. 7 is a flowchart illustrating a method of controlling an aerosol-generating device according to an embodiment; and

FIG. 8 is a flowchart illustrating a method of controlling an aerosol-generating device based on a current temperature of a heater according to an embodiment.

### DETAILED DESCRIPTION

Hereinafter, the embodiments disclosed in the present specification will be described in detail with reference to the accompanying drawings. The same or similar elements are denoted by the same reference numerals even though they are depicted in different drawings, and redundant descriptions thereof will be omitted. With regard to the description of the drawings, similar reference numerals may be used to refer to similar or related elements.

In the following description, with respect to constituent elements used in the following description, the suffixes "module" and "unit" are used only in consideration of facilitation of description, and do not have mutually distinguished meanings or functions. As used herein, the suffix "module" or "unit" may include a unit implemented in hardware, software, or firmware, and may be used interchangeably with other terms, for example, "logic," "logic block," "part," or "circuitry." A "module" or a "unit" may be a single integral component, or a minimum unit or part thereof, adapted to perform one or more functions. For example, the "module" or the "unit" may be implemented in the form of an application-specific integrated circuit (ASIC).

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and spirit of the present disclosure.

It will be understood that although the terms "first", "second", etc., may be used herein to describe various components, these components should not be limited by these terms. These terms are only used to distinguish one component from another component.

It will be understood that when a component is referred to as being "connected to" or "coupled to" another component, it may be directly connected to or coupled to another component, or intervening components may be present. On the other hand, when a component is referred to as being "directly connected to" or "directly coupled to" another component, there are no intervening components present.

As used herein, the singular form is intended to include the plural forms as well, unless the context clearly indicates otherwise.

Embodiments as set forth herein may be implemented as software including one or more instructions that are stored in a storage medium (e.g., a memory 17) that is readable by a machine (e.g., the aerosol-generating device 1). For example, a processor (e.g., the controller 12) of the machine (e.g., the aerosol-generating device 1) may invoke at least one of the one or more instructions stored in the storage medium, and may execute the same. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term "non-transitory" simply means that the storage medium is a tangible device, and does not include a signal (e.g., an electromagnetic wave), but this term does not differentiate between where data is semi-permanently stored in the storage medium and where the data is temporarily stored in the storage medium.

In the present disclosure, the directions of the aerosol-generating device 1 may be defined based on the orthogonal coordinate system. In the orthogonal coordinate system, the x-axis direction may be defined as a leftward-rightward direction of the aerosol-generating device 1. The y-axis direction may be defined as a forward-backward direction of the aerosol-generating device 1. The z-axis direction may be defined as an upward-downward direction of the aerosol-generating device 1.

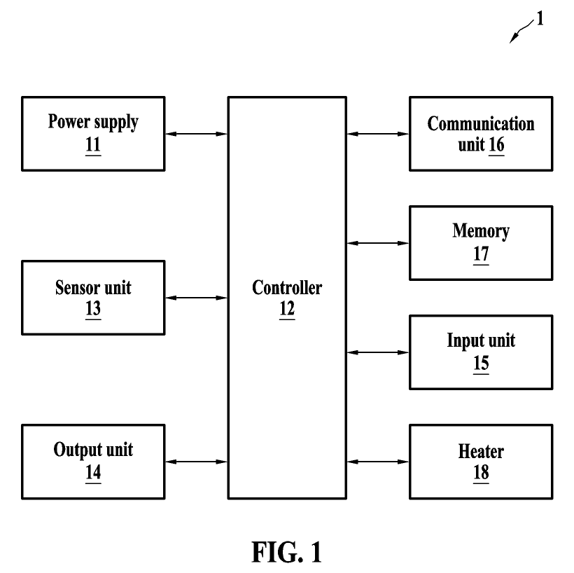

FIG. 1 is a block diagram of an aerosol-generating device according to an embodiment.

According to one embodiment, the aerosol-generating device 1 may include a power supply 11, a controller 12, a sensor unit 13, an output unit 14, an input unit 15, a communication unit 16, a memory 17, and/or a heater 18 and 24. However, the components included in the aerosol-generating device 1 are not limited to those shown in FIG. 1. That is, it will be understood by those skilled in the art related to the present embodiment that some of the components shown in FIG. 1 may be omitted or new components may be further included depending on the design of the aerosol-generating device 1.

According to one embodiment, the sensor unit 13 may detect the state of the aerosol-generating device 1 or the state of the surroundings of the aerosol-generating device 1, and may transmit the detected information to the controller 12. For example, the sensor unit 13 may include a temperature sensor, a puff sensor, an insertion detection sensor, a reuse detection sensor, an overly moist state detection sensor, a cigarette identification sensor, a cartridge detection sensor, a cap detection sensor, and/or a movement detection sensor. Meanwhile, the sensor unit 13 may further include various sensors, such as a liquid residual quantity sensor for detecting the residual quantity of liquid in the cartridge and an immersion sensor for detecting immersion of the aerosol-generating device 1.

According to one embodiment, the temperature sensor may detect a temperature to which the heater 18 and 24 is heated. The aerosol-generating device 1 may include a separate temperature sensor for detecting the temperature of the heater 18 and 24, or the heater 18 and 24 itself may serve as a temperature sensor. In an example, the temperature sensor may be used to measure impedance for the heater 18. The impedance for the heater 18 may correlate with the temperature of the heater 18. The temperature sensor may measure current and/or voltage applied to the heater 18 (or an induction coil). The impedance for the heater 18 may be obtained based on the measured current and/or voltage. The controller 12 may estimate the temperature of the heater 18 based on the obtained impedance.

In an example, the temperature sensor may include a resistance element (e.g., a thermistor), the resistance value of which varies in response to changes in the temperature of the heater 18 and 24. The temperature sensor may output a signal corresponding to the resistance value of the resistance element, and the controller 12 may determine the temperature of the heater 18 and 24 and/or a change in the temperature of the heater 18 and 24 based on the signal corresponding to the resistance value.

In another example, the temperature sensor may include a sensor that detects the resistance value of the heater 18 and 24. The temperature sensor may output a signal corresponding to the resistance value of the heater 18 and 24, and the controller 12 may determine the temperature of the heater 18 and 24 and/or a change in the temperature of the heater 18 and 24 based on the signal corresponding to the resistance value.

According to one embodiment, the temperature sensor may detect the temperature of the power supply 11. The temperature sensor may be disposed adjacent to the power supply 11. For example, the temperature sensor may be attached to one surface of the power supply 11 (e.g., a battery) and/or may be mounted on one surface of a printed circuit board. In an example, the aerosol-generating device 1 may include a power supply protection circuit module (PCM), and the temperature sensor may be disposed adjacent to the power supply 11 together with the power supply protection circuit module.

According to one embodiment, the temperature sensor may be disposed in a housing (not shown) of the aerosol-generating device 1 to detect the internal temperature of the housing (not shown).

According to one embodiment, the puff sensor may detect a user’s puff.

In an example, the puff sensor may include a pressure sensor. The pressure sensor may output a signal corresponding to the internal pressure of the aerosol-generating device 1, and the controller 12 may determine the user’s puff based on the signal corresponding to the internal pressure. Here, the internal pressure of the aerosol-generating device 1 may correspond to the pressure of an airflow path through which gas flows. The puff sensor may be disposed corresponding to the airflow path through which gas flows in the aerosol-generating device 1.

In another example, the puff sensor may include a temperature sensor. When the user’s puff occurs, temperature drop may temporarily occur in the airflow path, a space into which an aerosol-generating article is inserted (hereinafter referred to as an "insertion space"), and the heater 18 and 24. The controller 12 may determine the user’s puff based on a signal corresponding to the temperature of the airflow path output from the temperature sensor.

In still another example, the puff sensor may include both a pressure sensor and a temperature sensor. In this case, the temperature sensor may measure temperature used to calibrate the internal pressure measured by the pressure sensor. In one example, the puff sensor may calibrate a signal corresponding to the internal pressure based on the temperature measured by the temperature sensor, and may output the calibrated signal. In another example, the puff sensor may output a signal corresponding to the temperature measured by the temperature sensor and a signal corresponding to the internal pressure measured by the puff sensor. In this case, the controller 12 may receive the signals, and may calibrate the signal corresponding to the internal pressure based on the signal corresponding to the temperature.

In still another example, the puff sensor may include a capacitance sensor. The capacitance sensor may also be called a cap sensor or a capacitive sensor. When the user’s puff occurs, a temperature change and/or aerosol flow may occur in the insertion space of the aerosol-generating article, and accordingly, a dielectric constant in the insertion space may change. The controller 12 may determine the user’s puff based on a signal corresponding to the dielectric constant in the insertion space output from the capacitance sensor.

The puff sensor is not limited to the examples described above, and may be implemented as various sensors for detecting the user’s puff.

According to one embodiment, the insertion detection sensor may detect insertion and/or removal of the aerosol-generating article. The insertion detection sensor may be mounted adjacent to the insertion space. In addition, the insertion detection sensor may include any combination of the examples described above.

In an example, the insertion detection sensor may include a capacitance sensor. The capacitance sensor may include at least one conductor, and the at least one conductor may be disposed adjacent to the insertion space. When the aerosol-generating article is inserted into or removed from the insertion space, capacitance around the conductor may change. The controller 12 may determine insertion and/or removal of the aerosol-generating article based on a signal corresponding to the dielectric constant in the insertion space output from the capacitance sensor.

In another example, the insertion detection sensor may include an inductive sensor. The inductive sensor may include at least one coil, and the at least one coil may be disposed adjacent to the insertion space. If the aerosol-generating article (e.g., a wrapper of the aerosol-generating article) includes a conductor, when the aerosol-generating article is inserted into or removed from the insertion space, a change in magnetic field may occur around the coil through which current flows. The controller 12 may determine insertion and/or removal of the aerosol-generating article including a conductor based on the characteristics of the current output from or detected by the inductive sensor (e.g., frequency of alternating current, a current value, a voltage value, an inductance value, and an impedance value). Alternatively, a susceptor SUS or the like may be included in the aerosol-generating article (e.g., a medium portion of the aerosol-generating article). In this case, a change in magnetic field may also occur around the coil based on insertion or removal of the susceptor or the like into or from the insertion space, and the controller 12 may determine insertion and/or removal of the aerosol-generating article based on the characteristics of the current of the inductive sensor.

The insertion detection sensor is not limited to the examples described above, and may be implemented as various sensors (e.g., a proximity sensor) for detecting insertion and/or removal of the aerosol-generating article. In addition, the insertion detection sensor may include any combination of the examples described above. According to one embodiment, the insertion detection sensor may include a switch or the like for detecting pressing by the aerosol-generating article.

According to one embodiment, the reuse detection sensor may detect whether the aerosol-generating article is being reused. In an example, the reuse detection sensor may be a color sensor for detecting the color of the aerosol-generating article. If the aerosol-generating article is used by the user, a change in the color of a portion of the wrapper may occur due to the generated aerosol or heating. The color sensor may output a signal corresponding to an optical characteristic (e.g., wavelength of light) corresponding to the color of the wrapper based on the light reflected from the wrapper. When a change in the color of a portion of the wrapper is detected, the controller 12 may determine that the aerosol-generating article inserted into the insertion space has already been used.

According to one embodiment, the overly moist state detection sensor may detect whether the aerosol-generating article is in an overly moist state. For example, the overly moist state detection sensor may include a capacitance sensor. The capacitance sensor may include at least one conductor disposed adjacent to the insertion space. The controller 12 may determine whether the aerosol-generating article is in an overly moist state based on the level of a signal corresponding to the dielectric constant or the like output from the capacitance sensor. In an example, the controller 12 may check a level range within which the level of the signal is included based on a look-up table, and may determine the moisture content of the aerosol-generating article based on the checked level range.

According to one embodiment, the cigarette identification sensor may detect whether the aerosol-generating article is authentic and/or may detect the type of the aerosol-generating article.

In an example, the cigarette identification sensor may include an optical sensor for detecting an identification material (or an identification mark) located on the outer surface (e.g., the wrapper) of the aerosol-generating article. The optical sensor may radiate light toward the identification material (or the identification mark) of the aerosol-generating article, and may detect whether the aerosol-generating article is authentic and/or may detect the type of the aerosol-generating article based on the reflected light. For example, the identification material may include a material (i.e., a luminous material) that emits light of a specific wavelength band based on the light radiated thereto. The controller 12 may determine whether the aerosol-generating article is authentic and/or may determine the type of the aerosol-generating article based on the range of the wavelength.

In another example, the cigarette identification sensor may include a capacitance sensor. The dielectric constant in the insertion space may vary depending on the type of the aerosol-generating article inserted into the insertion space. The controller 12 may determine whether the aerosol-generating article is authentic and/or may determine the type of the aerosol-generating article based on a signal corresponding to the dielectric constant or the like in the insertion space output from the capacitance sensor.

In still another example, the cigarette identification sensor may include an inductive sensor. If a conductor is included in the wrapper and/or inner portion (e.g., the medium portion) of the aerosol-generating article inserted into the insertion space, when the aerosol-generating article is inserted into the insertion space, the characteristics of the current detected by the inductive sensor (e.g., frequency of alternating current, a current value, a voltage value, an inductance value, and an impedance value) may vary depending on the type of the aerosol-generating article inserted into the insertion space. The controller 12 may determine whether the inserted aerosol-generating article is authentic and/or may determine the type of the inserted aerosol-generating article based on the characteristics of the current output from or detected by the inductive sensor.

The cigarette identification sensor is not limited to the examples described above, and may be implemented as various sensors for detecting whether the aerosol-generating article is authentic and/or detecting the type of the aerosol-generating article. In addition, the cigarette identification sensor may include any combination of the examples described above.

According to one embodiment, the cartridge detection sensor may detect mounting and/or removal of the cartridge. For example, the cartridge detection sensor may include an inductive sensor, a capacitance sensor, a resistance sensor, a Hall sensor (Hall IC), and/or an optical sensor.

According to one embodiment, the cap detection sensor may detect mounting and/or removal of the cap. For example, the cap detection sensor may include an inductive sensor, a capacitance sensor, a resistance sensor, a contact sensor, a Hall sensor (Hall IC), and/or an optical sensor. The cap may cover at least a portion of the cartridge mounted in or inserted into the aerosol-generating device 1 or may cover at least a portion of the housing of the aerosol-generating device 1. When the cap is mounted in or removed from the housing, the cap detection sensor may output a signal corresponding to mounting or removal, and the controller 12 may determine mounting or removal of the cap based on the signal corresponding to mounting or removal.

According to one embodiment, the movement detection sensor may detect movement of the aerosol-generating device 1. The movement detection sensor may be implemented as at least one of an acceleration sensor or a gyro sensor.

According to one embodiment, the sensor unit 13 may further include at least one of a humidity sensor, an air pressure sensor, a magnetic sensor, a position sensor (global positioning system (GPS)), or a proximity sensor in addition to the sensors described above. The functions of the sensors can be intuitively deduced by those skilled in the art from the names thereof, and thus detailed descriptions thereof may be omitted.

According to one embodiment, the output unit 14 may output information about the state of the aerosol-generating device 1 to provide the same to the user. The output unit 14 may include, but is not limited to, a display, a haptic unit, and/or a sound output unit. For example, information about the aerosol-generating device 1 may include a charging/discharging state of the power supply 11 of the aerosol-generating device 1, a preheating state of the heater 18 and 24, an insertion/removal state of the aerosol-generating article and/or the cartridge, a mounting/removal state of the cap, or a state in which the use of the aerosol-generating device 1 is restricted (e.g., detection of an abnormal object). The display may visually provide the information about the state of the aerosol-generating device 1 to the user. For example, the display may include a light-emitting diode (LED), a liquid crystal display panel (LCD), and an organic light-emitting diode panel (OLED). If the display includes a touchpad, the display may also be used as the input unit 15. The haptic unit may haptically provide the information about the aerosol-generating device 1 to the user. For example, the haptic unit may include a vibration motor, a piezoelectric element, and an electrical stimulation device. The sound output unit may audibly provide the information about the aerosol-generating device 1 to the user. For example, the sound output unit may convert an electrical signal into an acoustic signal and may output the acoustic signal to the outside.

According to one embodiment, the power supply 11 may supply power used for operation of the aerosol-generating device 1. The power supply 11 may include one or more batteries. The power supply 11 may supply power so that the heater 18 and 24 is heated. In addition, the power supply 11 may supply power necessary for operation of the other components included in the aerosol-generating device 1, such as the controller 12, the sensor unit 13, the output unit 14, the input unit 15, the communication unit 16, and the memory 17. The power supply 11 may be a rechargeable battery or a disposable battery. For example, the power supply 11 may be a lithium polymer (LiPoly) battery without being limited thereto. The power supply 11 may be a replaceable (separation-type) battery (hereinafter referred to as a "removable battery"). The removable battery may be mounted in a battery accommodation portion provided in the aerosol-generating device 1 or may be removed from the battery accommodation portion. The removable battery may be charged in a wired and/or wireless manner.

According to one embodiment, the heater 18 and 24 may receive power from the power supply 11 to heat the aerosol-generating article (e.g., a cigarette) and/or a medium and/or an aerosol-generating substance in the cartridge. The aerosol-generating device 1 may include a heater 18 for heating the aerosol-generating article and/or a cartridge heater 24 for heating the cartridge (i.e., a solid and/or liquid medium).

According to one embodiment, the heater 18 and 24 may be an electro-resistive heater. For example, the electro-resistive heater may include an electrically resistive material such as a metal or a metal alloy including titanium, zirconium, tantalum, platinum, nickel, cobalt, chromium, hafnium, niobium, molybdenum, tungsten, tin, gallium, manganese, iron, copper, stainless steel, and nichrome. The electro-resistive heater may be implemented as a metal wire, a metal plate having an electrically conductive track disposed thereon, or a ceramic heating element.

According to one embodiment, the heater 18 and 24 may be an induction heater. For example, the induction heater may include a susceptor that generates heat through a magnetic field. A magnetic field may be generated by an induction coil by alternating current flowing through the induction coil. The magnetic field may pass through the heater, and an eddy current may be generated in the susceptor. The susceptor may be heated based on generation of the eddy current. According to one embodiment, the susceptor may be included in the inner portion (e.g., the medium portion) of the aerosol-generating article. In this case, the susceptor included in the inner portion of the aerosol-generating article may also be heated by the induction coil.

The heater 18 and 24 is not limited to the examples described above, and may include or be replaced with various heating methods, structures, and components for heating the aerosol-generating article and/or the cartridge.

According to one embodiment, the input unit 15 may receive information input from the user. For example, the input unit 15 may include a touch panel, a button, a keypad, a dome switch, a jog wheel, and a jog switch.

According to one embodiment, the memory 17 may be hardware storing various pieces of data processed in the aerosol-generating device 1. The memory 17 may store data processed and to be processed by the controller 12. For example, the memory 17 may include at least one type of storage medium among a flash memory type memory, a hard disk type memory, a multimedia card micro type memory, a card type memory (e.g., SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disc. For example, the memory 17 may store data on an operation time of the aerosol-generating device 1, the maximum number of puffs, the current number of puffs, at least one temperature profile, and the user’s smoking pattern.

According to one embodiment, the communication unit 16 may include at least one component for communication with other electronic devices (e.g., a portable electronic device). For example, the communication unit 16 may include a Bluetooth communication unit, a Bluetooth low energy (BLE) communication unit, a near-field communication unit, a wireless local area network (WLAN) communication unit, a Zigbee communication unit, an infrared data association (IrDA) communication unit, a Wi-Fi direct (WFD) communication unit, an ultra-wideband (UWB) communication unit, an Ant+ communication unit, a cellular network communication unit, an Internet communication unit, and a computer network (e.g., LAN or WAN) communication unit.

According to one embodiment, the controller 12 may control the overall operation of the aerosol-generating device 1. For example, the controller 12 may include at least one processor. The controller 12 may be implemented as an array of a plurality of logic gates or may be implemented as a combination of a general-purpose microcontroller unit (MCU) (or a microprocessor) and a memory in which a program executable by the MCU is stored. It will be understood by those skilled in the art that the controller may also be implemented as other forms of hardware.

According to one embodiment, the controller 12 may control the supply of power from the power supply 11 to the heater 18 and 24 to control the temperature of the heater 18 and 24. The controller 12 may control the temperature of the heater 18 and 24 and/or power supplied to the heater 18 and 24 based on the temperature of the heater 18 and 24 detected by the temperature sensor (e.g., the sensor unit 13). The controller 12 may control the temperature of the heater 18 and 24 and/or power supplied to the heater 18 and 24 based on the temperature profile and/or the power profile stored in the memory 17.

According to one embodiment, the controller 12 may control a power conversion circuit (not shown) electrically connected to the heater 18 and 24 and the power supply 11 to control power (e.g., voltage and/or current) supplied to the heater 18 and 24. For example, the power conversion circuit may include a DC/DC converter (e.g., a buck converter, a buck-boost converter, a boost converter, or a Zener diode) that converts power to be supplied to the heater 18 and 24 and a DC/AC converter (e.g., an inverter) that converts power to be supplied to the induction coil (not shown). The DC/AC converter may be implemented as a full-bridge circuit or a half-bridge circuit including a plurality of switching elements. For example, the power conversion circuit may include at least one switching element, such as a bipolar junction transistor (BJT) or a field effect transistor (FET).

According to one embodiment, the controller 12 may control the frequency and/or duty ratio of a current pulse input to at least one switching element of the power conversion circuit (not shown) to control the current and/or the voltage supplied to the heater 18 and 24. The duty ratio for the on/off operation of the switching element may correspond to a ratio of the voltage output from the power conversion circuit to the voltage output from the power supply 11.

According to one embodiment, the controller 12 may control power supplied to the heater 18 and 24 using at least one of a pulse width modulation (PWM) scheme or a proportional-integral-differential (PID) scheme. For example, the controller 12 may perform control using the PWM scheme such that a current pulse having a predetermined frequency and a predetermined duty ratio is supplied to the heater 18 and 24. The controller 12 may control the frequency and duty ratio of the current pulse to control power supplied to the heater 18 and 24. For example, the controller 12 may determine, based on the temperature profile, a target temperature to be controlled. The controller 12 may control power supplied to the heater 18 and 24 using the PID scheme, which is a feedback control scheme using a difference value between the temperature of the heater 18 and the target temperature, a value obtained by integrating the difference value with respect to time, and a value obtained by differentiating the difference value with respect to time.

According to one embodiment, the controller 12 may determine, based on the power profile, target power to be controlled. The controller 12 may control power supplied to the heater 18 and 24 so as to correspond to the preset target power over time.

According to one embodiment, the controller 12 may detect power supplied to the heater 18 and 24 to determine the user’s puff. In more detail, the controller 12 may control power supplied to the heater 18 and 24 using the proportional-integral-differential (PID) scheme. When the user’s puff occurs, temperature drop may temporarily occur in a space into which the aerosol-generating article is inserted (hereinafter referred to as an insertion space) and the heater 18 and 24. Accordingly, the power (or the current) supplied to the heater 18 and 24 may change during control of the power using the PID scheme. The controller 12 may determine the user’s puff based on the change in the power controlled.

According to one embodiment, the controller 12 may prevent the heater 18 and 24 from overheating. For example, the controller 12 may control, based on the temperature of the heater 18 and 24 exceeding a preset limit temperature, operation of the power conversion circuit such that the amount of power supplied to the heater 18 and 24 is reduced or the supply of power to the heater 18 and 24 is interrupted.

According to one embodiment, the controller 12 may control charging/discharging of the power supply 11. For example, the controller 12 may check the temperature of the power supply 11 using the temperature sensor (e.g., the sensor unit 13). If the temperature of the power supply 11 is equal to or higher than a first limit temperature, the controller 12 may interrupt charging of the power supply 11. If the temperature of the power supply 11 is equal to or higher than a second limit temperature, the controller 12 may interrupt use of the power stored in the power supply 11 (e.g., discharging). The controller 12 may calculate the remaining amount of the power stored in the power supply 11. For example, the controller 12 may calculate the remaining capacity of the power supply 11 based on a voltage and/or current detection value of the power supply 11.

According to one embodiment, the controller 12 may control the supply of power to the heater 18 and 24 based on a result of the detection by the sensor unit 13.

According to one embodiment, the controller 12 may control the supply of power to the heater 18 and 24 based on insertion and/or removal of the aerosol-generating article into and/or from the insertion space. For example, upon determining that the aerosol-generating article has been inserted into the insertion space using the insertion detection sensor (e.g., the sensor unit 13), the controller 12 may perform control such that power is supplied to the heater 18 and 24. Upon determining that the aerosol-generating article has been removed from the insertion space using the insertion detection sensor (e.g., the sensor unit 13), the controller 12 may interrupt the supply of power to the heater 18 and 24. The controller 12 may determine that the aerosol-generating article has been removed from the insertion space when the temperature of the heater 18 and 24 is equal to or higher than a limit temperature or when the temperature change slope of the heater 18 and 24 is equal to or greater than a preset slope.

According to one embodiment, the controller 12 may control, based on the state of the aerosol-generating article, a power supply time and/or the amount of power supplied to the heater 18 and 24. For example, upon determining that the aerosol-generating article is in an overly moist state using the overly moist state detection sensor (e.g., the sensor unit 13), the controller 12 may increase a time during which power is supplied to the heater 18 and 24 (e.g., a preheating time).

According to one embodiment, the controller 12 may control the supply of power to the heater 18 and 24 based on whether the aerosol-generating article is being reused. For example, upon determining that the aerosol-generating article has already been used, the controller 12 may interrupt the supply of power to the heater 18 and 24.

According to one embodiment, the controller 12 may control the supply of power to the heater 18 and 24 based on whether the cartridge has been coupled and/or removed. For example, upon determining that the cartridge has been removed using the cartridge detection sensor (e.g., the sensor unit 13), the controller 12 may interrupt the supply of power to the heater 18 or 24 or may perform control such that power is not supplied to the heater 18 and 24.

According to one embodiment, the controller 12 may control the supply of power to the heater 18 and 24 based on whether the aerosol-generating substance in the cartridge has been exhausted. For example, upon determining that the temperature of the heater 18 and 24 exceeds a limit temperature during preheating of the heater 18 and 24 (i.e., in the preheating section), the controller 12 may determine that the aerosol-generating substance in the cartridge has been exhausted. Upon determining that the aerosol-generating substance in the cartridge has been exhausted, the controller 12 may interrupt the supply of power to the heater 18 and 24.

According to one embodiment, the controller 12 may control the supply of power to the heater 18 and 24 based on whether use of the cartridge is possible. For example, upon determining, based on data stored in the memory 17, that the current number of puffs is equal to or greater than the maximum number of puffs set for the cartridge, the controller 12 may determine that use of the cartridge is impossible. Alternatively, when a total time period during which the heater 18 and 24 is heated is equal to or longer than a preset maximum time period or when the total amount of power supplied to the heater 18 and 24 is equal to or greater than a preset maximum amount of power, the controller 12 may determine that use of the cartridge is impossible. In this case, the controller 12 may interrupt the supply of power to the heater 18 or 24 or may perform control such that power is not supplied to the heater 18 and 24.

According to one embodiment, the controller 12 may control the supply of power to the heater 18 and 24 based on the user’s puff. For example, the controller 12 may determine whether a puff occurs and/or the intensity of a puff using the puff sensor (e.g., the sensor unit 13). When the number of puffs reaches a preset maximum number of puffs and/or when no puff is detected for a preset time period or longer, the controller 12 may interrupt the supply of power to the heater 18 and 24. When a puff is detected, the controller 12 may control the supply of power to the heater 18 and 24.

According to one embodiment, the controller 12 may control the supply of power to the heater 18 and 24 based on whether the aerosol-generating article (or the cartridge) is authentic and/or the type of the aerosol-generating article (or the cartridge). For example, the controller 12 may determine whether the aerosol-generating article is authentic and/or may determine the type of the aerosol-generating article using the cigarette identification sensor (e.g., the sensor unit 13). In an example, upon determining that the aerosol-generating article (or the cartridge) is inauthentic, the controller 12 may interrupt the supply of power to the heater 18 and 24. Upon determining that the aerosol-generating article (or the cartridge) is authentic, the controller 12 may control (e.g., commence) the supply of power to the heater 18 and 24. In another example, the controller 12 may control the supply of power to the heater 18 and 24 differently depending on the type of the aerosol-generating article (or the cartridge). In more detail, upon determining that the aerosol-generating article (or the cartridge) is a first aerosol-generating article (or a first cartridge), the controller 12 may control the temperature of the heater 18 and 24 and/or power based on a first temperature profile (or a first power profile), and upon determining that the aerosol-generating article (or the cartridge) is a second aerosol-generating article (or a second cartridge), the controller 12 may control the temperature of the heater 18 and 24 and/or power based on a second temperature profile (or a second power profile).

According to one embodiment, the controller 12 may control the output unit 14 based on a result of detection by the sensor unit 13. For example, when the number of puffs counted using the puff sensor (e.g., the sensor unit 13) reaches a preset number, the controller 12 may control the output unit 14 to visually, haptically, and/or audibly provide information that operation of the aerosol-generating device 1 will end soon. For example, the controller 12 may control the output unit 14 to visually, haptically, and/or audibly provide information about the temperature of the heater 18 and 24.

According to one embodiment, based on occurrence of a predetermined event, the controller 12 may store a history of the corresponding event in the memory 17 and may update the history. For example, the event may include events performed in the aerosol-generating device 1, such as detection of insertion of the aerosol-generating article, commencement of heating of the aerosol-generating article, detection of puff, termination of puff, detection of overheating of the heater 18 and 24, detection of application of overvoltage to the heater 18 and 24, termination of heating of the aerosol-generating article, on/off operation of the aerosol-generating device 1, commencement of charging of the power supply 11, detection of overcharging of the power supply 11, and termination of charging of the power supply 11. For example, the history of the event may include the occurrence date and time of the event and log data corresponding to the event. For example, when the predetermined event is detection of insertion of the aerosol-generating article, the log data corresponding to the event may include data on a value detected by the insertion detection sensor (e.g., the sensor unit 13). For example, when the predetermined event is detection of overheating of the heater 18 and 24, the log data corresponding to the event may include data on the temperature of the heater 18 and 24, the voltage applied to the heater 18 and 24, and the current flowing through the heater 18 and 24.

According to one embodiment, the controller 12 may control the communication unit 16 to form a communication link with an external device such as a user’s mobile terminal.

According to one embodiment, upon receiving data on authentication from an external device via the communication link, the controller 12 may release restriction on use of at least one function (e.g., a heating function) of the aerosol-generating device 1. For example, the data on authentication may include the user’s birthday, an identification number uniquely identifying the user, and whether authentication is completed by the user.

According to one embodiment, the controller 12 may transmit data on the state of the aerosol-generating device 1 (e.g., remaining capacity of the power supply 11 and operation mode) to the external device via the communication link. The transmitted data may be output through a display or the like of the external device.

According to one embodiment, upon receiving a request to search for the location of the aerosol-generating device 1 from the external device via the communication link, the controller 12 may control the output unit 14 to perform an operation corresponding to location search. For example, the controller 12 may perform control such that the haptic unit generates vibration or the display outputs objects corresponding to location search and termination of search.

According to one embodiment, upon receiving firmware data from the external device via the communication link, the controller 12 may perform firmware update.

According to one embodiment, the controller 12 may transmit data on a value detected by the at least one sensor unit 13 to an external server (not shown) via the communication link, and may receive, from the server, and store a learning model generated by learning the detected value through machine learning such as deep learning. The controller 12 may perform the operation of determining the user’s puff pattern and the operation of generating the temperature profile using the learning model received from the server.

Although not shown in FIG. 1, the aerosol-generating device 1 may further include a power supply protection circuit. The power supply protection circuit may include at least one switching element, and may block an electric path to the power supply 11 in response to overcharging and/or overdischarging of the power supply 11. The aerosol-generating device 1 may further include a connection interface such as a universal serial bus (USB) interface, and may be connected to other external devices through the connection interface to transmit and receive information or charge the power supply 11.

The aerosol-generating article mentioned in the present disclosure may include at least one aerosol-generating rod (e.g., a medium portion) and at least one filter rod. The heater 18 may be disposed to correspond to the at least one aerosol-generating rod, and may be designed differently depending on the arrangement order and/or positions of the aerosol-generating rod and the filter rod. The aerosol-generating rod may contain at least one of nicotine, an aerosol-generating substance, and an additive. For example, the aerosol-generating substance may include glycerin (e.g., vegetable glycerin (VG)) and/or propylene glycol (PG) and may also include various other substances. For example, the additive may include a flavoring agent and/or an organic acid and may also include various other substances. For example, the aerosol-generating rod may include an aerosol-generating substrate (e.g., a sheet) impregnated with a liquid non-tobacco substance (e.g., an aerosol-generating substance and/or nicotine) and/or may contain a solid tobacco substance (e.g., leaf tobacco and reconstituted tobacco). The tobacco substance may be contained in the aerosol-generating rod in various forms, such as shredded tobacco, granules, and powder. According to one embodiment, the additive of the aerosol-generating rod may include an alkaline substance. Based on the alkaline substance, nicotine contained in the tobacco substance in the aerosol-generating rod may have an alkaline pH (e.g., pH 7.0 or higher). In this case, freebase nicotine may be released from the aerosol-generating rod even at a low temperature. According to one embodiment, the aerosol-generating rod may include two or more aerosol-generating rods, each of which may contain a tobacco substance and/or a non-tobacco substance. Meanwhile, although not shown, the at least one aerosol-generating rod and the at least one filter rod may individually and/or integrally be wrapped by at least one wrapper. In the present disclosure, the aerosol-generating article may be referred to as a stick.

The cartridge mentioned in the present disclosure may contain an aerosol-generating substance having any one state among a liquid state, a solid state, a gaseous state, and a gel state. The aerosol-generating substance may include a liquid composition. For example, the liquid composition may be a liquid containing a tobacco-containing substance including a volatile tobacco flavor component or may be a liquid containing a non-tobacco substance. Meanwhile, the cartridge may include a storage part that contains the aerosol-generating substance and/or a liquid delivery part that is impregnated with (contains) the aerosol-generating substance. For example, the liquid delivery part may include a wick formed of, e.g., cotton fiber, ceramic fiber, glass fiber, or porous ceramic. The cartridge heater 24 may be included in the cartridge in a coil-shaped structure surrounding (or wound around) the liquid delivery part or a structure contacting one side of the liquid delivery part. Alternatively, the cartridge heater 24 may be included in the aerosol-generating device 1, which is removable from the cartridge.

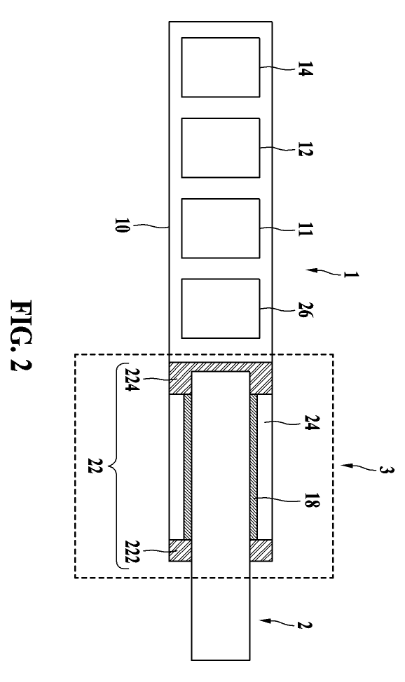

FIG. 2 illustrates an aerosol-generating device according to an embodiment.

According to one embodiment, the aerosol-generating device 1 may include a housing 10, the power supply 11, the controller 12, a sensor unit (e.g., the sensor unit 13 of FIG. 1), the output unit 14, a heating circuit 26, and/or a heater assembly 3. However, it will be understood by those skilled in the art related to the present embodiment that the components included in the aerosol-generating device 1 are not limited to those shown in FIG. 2 and that some of the components may be omitted or new components may be further included.

The aerosol-generating device 1 shown in FIG. 2 may be referred to as an "external heating-type" aerosol-generating device that heats the outer side of an aerosol-generating article (e.g., a cigarette) 2. In the drawings below, a description of configurations identical to those shown in FIG. 1 will be omitted.

According to one embodiment, the housing 10 may provide a space that is open upwardly to allow the aerosol-generating article 2 to be inserted thereinto. In the present disclosure, the space that is open upwardly may be referred to as an insertion space. The insertion space may be formed so as to be depressed in the housing 10 to a predetermined depth so that at least a portion of the aerosol-generating article 2 may be inserted thereinto. The depth of the insertion space may be equal to or greater than the length of a region of the aerosol-generating article 2 in which an aerosol-generating substance and/or a medium is contained. The lower end of the aerosol-generating article 2 may be inserted into the housing 10, and the upper end of the aerosol-generating article 2 may protrude outside the housing 10. A user may hold the upper end of the aerosol-generating article 2, which is exposed to the outside, in the mouth of the user and inhale an aerosol.

In the illustrated embodiment, the housing 10 and the heater assembly 3 are illustrated as being separate from each other, but according to the embodiment, the housing 10 may include the heater assembly 3 inside.

According to one embodiment, the heater assembly 3 may fix the aerosol-generating article 2 and heat the fixed aerosol-generating article 2. The heater assembly 3 may be elongated upward around a space into which the aerosol-generating article 2 is inserted (that is, an insertion space). For example, the heater assembly 3 may be disposed to surround at least a portion of the insertion space. For example, the heater assembly 3 may include a tube shape (e.g., a cylindrical shape) with a cavity formed therein. The heater assembly 3 may include a shape including a cavity formed therein and surrounding the cavity. The heater assembly 3 may be disposed so as to surround at least a portion of the insertion space. The heater assembly 3 may heat the outer side of the aerosol-generating article 2 inserted into the cavity.

According to one embodiment, the heater assembly 3 may include the heater 18, a support member 22, and a vacuum member 24. The vacuum member 24 may be omitted.

The heater 18 may be disposed around at least a portion of the aerosol-generating article 2 inserted into the aerosol-generating device 1.

According to one embodiment, the heater 18 may include an electro-resistive heater. For example, the electro-resistive heater may include an electro-resistive material, which is provided on the inner side (e.g., in the cavity or on the inner surface) or outer side (e.g., on the outer surface) thereof, and may generate heat as current flows through the electro-resistive material. In this case, the electro-resistive heater may be electrically connected to the power supply 11, and may directly generate heat using current received from the power supply 11. In addition, an induction coil may be omitted. If the heater 18 is an electro-resistive heater, heat may be generated through current flow through the tubular electro-resistive heater (e.g., a film heater), and thus a separate induction coil may be omitted.

According to one embodiment, the heater 18 may include an induction heater. In the case of an induction heater, the aerosol-generating device 1 may include an external heating-type heater implemented as a tubular susceptor and may include an induction coil surrounding at least a portion of the external heating-type heater (e.g., disposed outside the heater so as to correspond to the length of at least a portion of the heater). In addition, the induction coil may include a fan coil.

According to one embodiment, the heater 18 may be a multi-heater, and a first heater and a second heater may be disposed side by side in the longitudinal direction so as to surround at least a portion of the insertion space. The first heater and the second heater may operate as an electro-resistive heater and/or an induction heater, and may be heated sequentially or simultaneously. Meanwhile, if the heater 18 is an induction heater, the aerosol-generating device 1 may include a first induction coil and a second induction coil. The first induction coil and the second induction coil may be disposed at positions corresponding to the positions of the first heater and the second heater in the longitudinal direction, respectively. Alternatively, the first heater and the second heater may be disposed at positions corresponding to the positions of a first portion and a second portion of one heater 18 in the longitudinal direction, respectively.

Although not shown in FIG. 2, the aerosol-generating device 1 may further include an internal heating-type heater that heats the inner side of the aerosol-generating article 2. In this case, the internal heating-type heater may heat the inner side of the aerosol-generating article 2, and the heater 18 may heat the outer side of the aerosol-generating article 2.

According to one embodiment, the internal heating-type heater may be elongated upwardly in the space into which the aerosol-generating article 2 is inserted (i.e., the insertion space). For example, the internal heating-type heater may include a rod-shaped or needle-shaped heating element. Alternatively, the internal heating-type heater may include various other heating elements, such as a tubular heating element or a plate-shaped heating element. The internal heating-type heater may be inserted through the lower portion of the aerosol-generating article 2.

According to one embodiment, the internal heating-type heater may include an electro-resistive heater and/or an induction heater, and the repeated description thereof is omitted.

For example, in the case of an induction internal heating-type heater, the aerosol-generating device 1 may include an induction coil surrounding at least a portion of the internal heating-type heater (e.g., disposed outside the internal heating-type heater so as to correspond to the length of at least a portion of the internal heating-type heater). In this case, a magnetic flux concentrator may be further provided outside the induction coil in order to increase efficiency of induction heating. The induction internal heating-type heater may include a susceptor, and may generate heat based on a magnetic field generated by the induction coil. According to one embodiment, the induction internal heating-type heater (e.g., the susceptor) (or an internal heating-type heater module including the same) may be disposed to be removable from the housing 10.

According to one embodiment, the internal heating-type heater may be a multi-heater. The multi-heater may include a first heater and a second heater, and may be inserted into the aerosol-generating article 2. The first heater and the second heater may be disposed side by side in the longitudinal direction. The first heater and the second heater may operate as an electro-resistive heater and/or an induction heater, and may be heated sequentially or simultaneously. In this case, the first heater and the second heater may be disposed at positions corresponding to the positions of two or more aerosol-generating rods in the longitudinal direction, respectively. Alternatively, the first heater and the second heater may be disposed at positions corresponding to the positions of a first portion and a second portion of one aerosol-generating rod in the longitudinal direction, respectively. Meanwhile, if the internal heating-type heater is an induction heater, the aerosol-generating device 1 may include a first induction coil and a second induction coil, and the first induction coil and the second induction coil may be disposed at positions corresponding to the positions of the first heater and the second heater in the longitudinal direction, respectively. Alternatively, the first heater and the second heater may be disposed at positions corresponding to the positions of a first portion and a second portion of one heater 18 in the longitudinal direction, respectively. In addition, three or more heaters and/or three or more induction coils may be included.

According to one embodiment, the susceptor may be disposed on (or included in) the inner side (e.g., the medium portion) of the aerosol-generating article 2. The susceptor included inside the aerosol-generating article 2 may be implemented to be heated based on a magnetic field generated by the induction coil.

The support member 22 may be removably or integrally formed. When the heater 18 has a cylindrical shape, the removable support member 22 may include a first support member 222 coupled to an upper portion of the cylinder shape and a second support member 224 coupled to a lower portion of the cylinder shape. The integrally formed support member may have a cylindrical cavity. The heater 18 may be disposed inside the cavity.

According to one embodiment, the vacuum member 24 may be disposed outside the heater 18. For example, when the support member 22 is removable, the vacuum member 24 may connect the first support member 222 and the second support member 224 of the support member 22 to surround at least a portion of the heater 18. For example, when the support member 22 is integrally formed, the vacuum member 24 may surround at least a portion of the integrally formed support member 22. Through the vacuum member 24, the amount of heat emitted from the heater 18 in the radially outward direction and released outside the housing 10 may be reduced.

The heating circuit 26 may be connected to the heater 18. For example, the heating circuit 26 may be a circuit for controlling a signal supplied to a heater 28. For example, the signal supplied to the heater 28 may be a current pulse signal controlled based on the PWM method. That is, different signals supplied to the heater 18 may be generated based on the heating circuit 26.

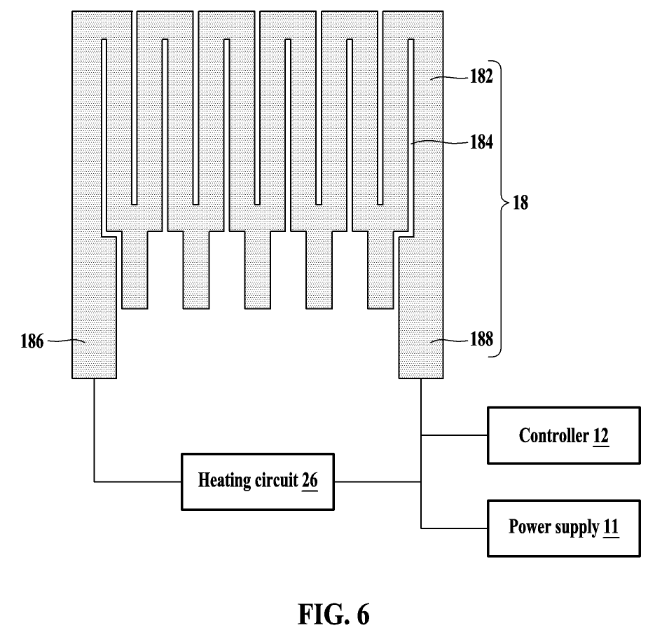

The controller 12 may control the signal supplied to the heater 18 through the heating circuit 26. The heating circuit 26 of the aerosol-generating device 1 will be described in more detail below with reference to FIG. 6.

According to one embodiment, the aerosol-generating device 1 may be provided with an airflow channel through which air flows. For example, the housing 10 may include a structure (e.g., a hole) through which outside air may be introduced into the housing 10. The air introduced into the housing 10 may be introduced into the aerosol-generating article 2 through the lower end (i.e., upstream side) of the aerosol-generating article 2. An aerosol generated based on heating of the aerosol-generating article 2 may be inhaled into the user’s oral cavity together with the introduced air through the upper end (i.e., downstream side) of the aerosol-generating article 2.

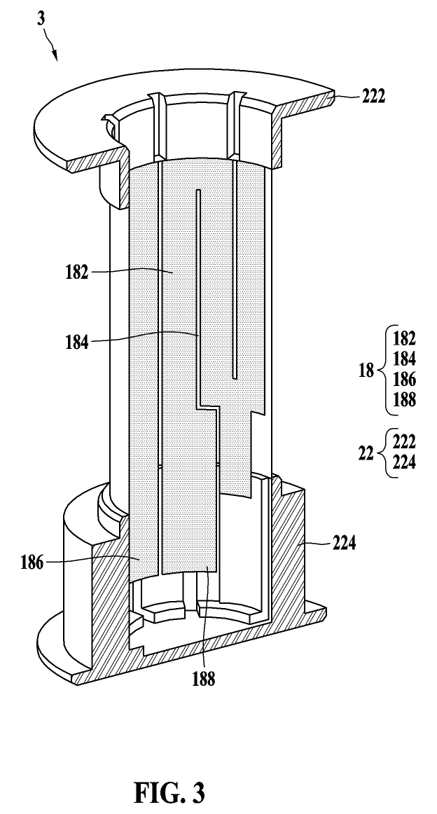

FIG. 3 is an exploded view of a heater assembly according to an embodiment.

According to one embodiment, the heater assembly 3 may include the heater 18 and the support member 22. In the drawings below, a description of configurations identical to those shown in FIG. 2 will be omitted.

The heater 18 may be disposed in at least a portion of an aerosol-generating device (e.g., the aerosol-generating article 2 of FIG. 2) inserted into an aerosol-generating device (e.g., the aerosol-generating article 1 of FIGS. 1 and 2). The heater 18 may include an electro-resistive material and may generate heat as current flows through the electro-resistive material.

The heater 18 may include a conductive portion 182, an insulating portion 184, a first electrode 186, and a second electrode 188.

The conductive portion 182 is formed of an electro-resistive material and allows current to flow. Current does not flow through the insulating portion 184. For example, the insulating portion 184 may be formed by laser cutting the electro-resistive material, and there is no limitation on the method of forming the conductive portion 182. Based on a pattern shape (e.g., a heater pattern) of the conductive portion 182 and the insulating portion 184, a path of the current flowing through the electro-resistive material forming the heater 18 and the total resistance may be changed. For example, as the pattern shape becomes more complex, the path of the current flowing through the heater 18 becomes longer, and the total resistance of the heater 18 may increase. For example, the simpler the pattern shape, the shorter the path of current flowing through the heater 18 and the lower the total resistance. In one example, the pattern shape of the heater 18 may be a serpentine shape.

In one example, when the temperature of the heater 18 increases, the resistance within the heater 18 may increase due to a temperature coefficient of resistance (TCR). When the resistance within the heater 18 increases, the performance of the heater 18 may degrade. In order to prevent performance degradation of the heater 18, when the size of a voltage supplied to the heater 18 is increased, the circuit configuration may become complicated. In order to prevent performance degradation of the heater 18, when the heater 18 is designed using a material with a small TCR, an initial inrush current problem in the circuit may occur.

In one example, the heater 18 may have a pattern, and the pattern may act as a coil in a circuit forming the heater 18 according to the pattern shape and pattern length of the heater 18. The inductance generated by the heater 18 may act as a factor that changes the reactance of the current flowing in the circuit forming the heater 18. The inductance generated by the heater 18 may act as a factor that changes the impedance of the circuit including the heater 18.

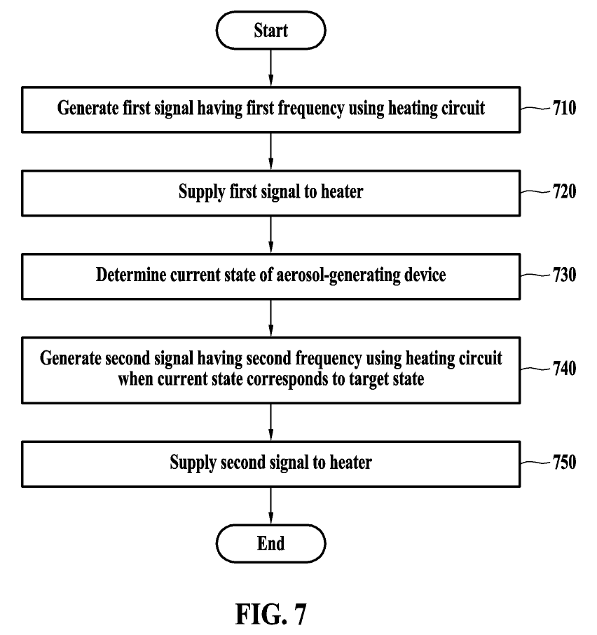

By controlling the signal supplied to the heater 18 through the heating circuit, the total reactance and impedance values for the circuit forming the heater 18 may be changed. For example, the signal supplied to the heater 28 may be a current pulse signal controlled based on the PWM method. A method of controlling the signal supplied to the heater 18 through the heating circuit will be described in more detail below with reference to FIG. 7.

The heater 18 may have a cylindrical shape with a cavity formed therein, or may have a shape including a cavity formed therein and surrounding the cavity. The heater 18 may heat and fix an aerosol-generating article (e.g., the aerosol-generating article 2 of FIG. 2) inserted into an aerosol-generating device.

In one example, the first electrode 186 and the second electrode 188 are disposed side by side and completely insulated by the insulating portion 184. Different voltages may be applied to the first electrode 186 and the second electrode 188 to cause current to flow to the heater 18.

The support member 22 may include the first support member 222 and the second support member 224. The first support member 222 and the second support member 224 may be fixed so that the heater 18 has a cylindrical shape.

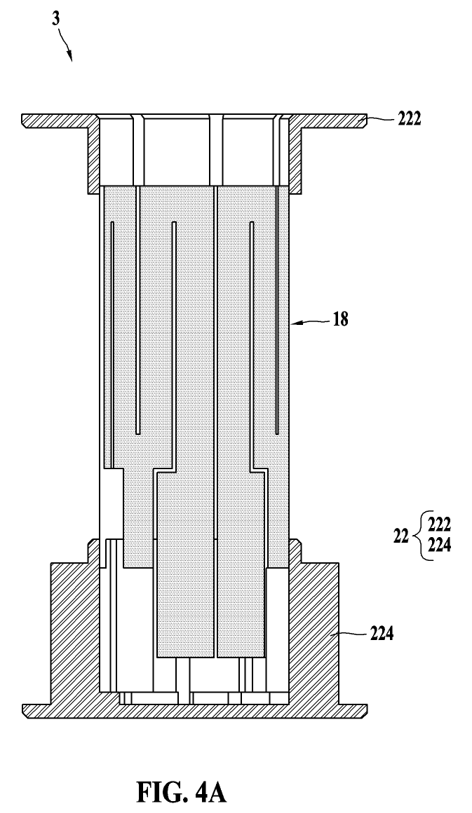

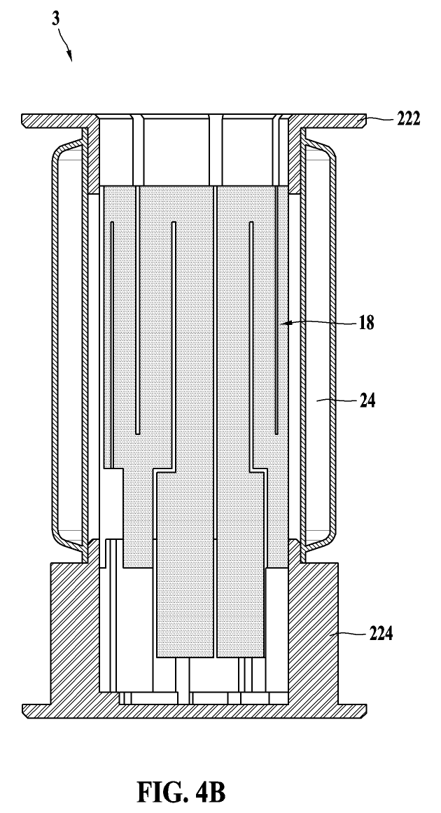

FIGS. 4A and 4B are exploded cross-sectional views of a removable heater assembly according to an embodiment.

According to one embodiment, the heater assembly 3 may include the heater 18 and the removable support member 22. The removable support member 22 may include the first support member 222 and the second support member 224. The heater assembly 3 may further include the vacuum member 24. The vacuum member 24 may connect the first support member 222 and the second support member 224 to surround at least a portion of the heater 18. Through the vacuum member 24, the amount of heat emitted from the heater 18 in the radially outward direction and released to the outside may be reduced. In the drawings below, a description of configurations identical to those shown in FIGS. 2 or 3 will be omitted.

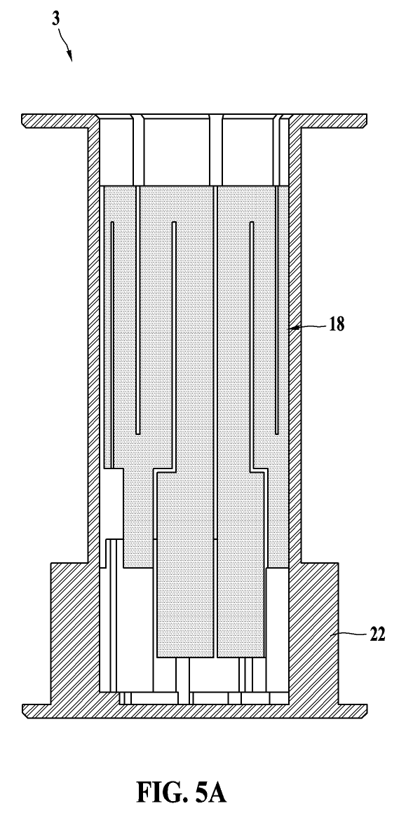

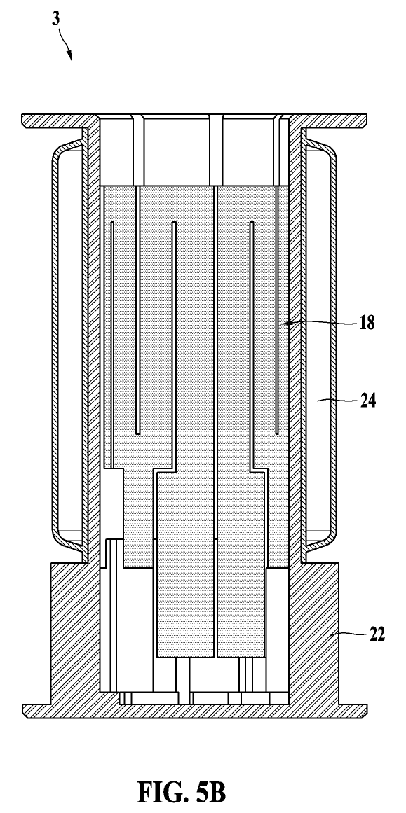

FIGS. 5A and 5B are exploded cross-sectional views of an integrally formed heater assembly according to an embodiment.

According to one embodiment, the heater assembly 3 may include the heater 18 and the integrally formed support member 22. The integrally formed support member 22 may have a cylindrical cavity. The heater 18 may be disposed inside the cavity. The support member 22 may fix the heater 18 disposed therein. The heater assembly 3 may further include the vacuum member 24. The vacuum member 24 may surround at least a portion of the support member 22. In the drawings below, a description of configurations identical to those shown in FIGS. 2 or 3 will be omitted.

FIG. 6 illustrates a configuration of an aerosol-generating device according to an embodiment.

According to one embodiment, an aerosol-generating device (e.g., the aerosol-generating device 1 of FIGS. 1 and 2) may include the heater 18, the heating circuit 26, the power supply 11, and the controller 12.

The heater 18 may include a conductive portion 182, an insulating portion 184, a first electrode 186, and a second electrode 188. A heater pattern may be formed by the conductive portion 182 and the insulating portion 184. Although the heater 18 of FIG. 6 is illustrated as having a serpentine shape, the heater pattern is not limited to the illustrated embodiment.

The heating circuit 26 may be connected to the heater 18. The power supply 11 may supply power for the operation of the heater 18 and the heating circuit 26. The controller 12 may control the signal supplied to the heater 18 through the heating circuit 26.

The heater 18 may have a cylindrical shape with a cavity formed therein, or may have a shape including a cavity formed therein and surrounding the cavity. Based on the heater pattern formed on the heater 18, the heater 18 may act as a coil in a circuit (e.g., the heating circuit 26) forming the heater 18. The inductance occurring by the heater pattern may act as a factor that changes the reactance of the current flowing in the circuit. The inductance occurring by the heater pattern may act as a factor that changes the impedance of the circuit.

For example, as an inductance value occurring by the heater 18 increases, the total impedance of the circuit including the heater 18 may increase. For example, as the inductance value occurring by the heater 18 decreases, the total impedance of the circuit may be reduced. For example, the circuit including the heater 18 may include additional default resistance. For example, the default resistance may have a value of 0.5 Ω to 1.5 Ω, and is not limited to embodiments to be described.

In one embodiment, the heating circuit 26 may be a circuit for controlling the signal supplied to the heater 18. The controller 12 may generate a first signal having a first frequency using the heating circuit 26. In one example, the first frequency may be greater than or equal to 100 kilohertz (KHz).

In one embodiment, the controller 12 may supply the first signal to the heater 18. In one example, the total impedance of the circuit including the heater 18 may be based on the inductive reactance occurring by the heater 18. The inductive reactance occurring by the heater 18 may be determined by Z = 2πfL. The total impedance value of the circuit may be expressed as the sum of the inductive reactance and the resistance value of the circuit. When the frequency of an alternating current (AC) signal supplied to the heater 18 changes, the total impedance value of the circuit may change based on the inductive reactance.

In one embodiment, the controller 12 may determine a current state of the aerosol-generating device. In one example, the current state of the aerosol-generating device may be determined based on the time at which power is supplied to the heater 18 from the power supply 11, the time at which the first signal is supplied, the temperature of the heater 18, the magnitude of the resistance of the heater 18, and the total impedance magnitude of the circuit including the heater 18. Examples of the current state of the aerosol-generating device and the method of determining the current state are not limited to the described embodiment.

In one embodiment, the controller 12 may generate a second signal having a second frequency using the heating circuit 26 when the current state corresponds to a target state. The target state may be a preset state.

In one embodiment, the target state may be a state in which a timer associated with the first signal has expired. For example, the timer associated with the first signal may operate at the same time as the first signal having the first frequency is first generated (or supplied). As the first signal is supplied to the heater 18, the temperature of the heater 18 may gradually increase. When the temperature of the heater 18 increases, the resistance within the heater 18 may increase due to the TCR, and based on this, the total impedance value of the circuit may increase. For example, an arbitrary impedance threshold value may be set to prevent performance degradation of the heater 18. Based on the arbitrary impedance threshold value, an arbitrary temperature threshold value of the heater 18 may be set. For example, the time at which the timer associated with the first signal has expired may be the time until the temperature of the heater 18 reaches the arbitrary temperature threshold value of the heater 18. The controller 12 may determine that the state in which the timer associated with the first signal has expired is the target state, and may generate the second signal having the second frequency using the heating circuit 26 when the current state corresponds to the target state.

In one embodiment, the target state may be a state in which the current temperature of the heater 18 corresponds to a target temperature. For example, the target temperature may be the arbitrary temperature threshold value of the heater 18 set based on the arbitrary impedance threshold value. The controller 12 may determine the state, in which the temperature of the heater 18 corresponds to the target temperature, as the target state, and may generate the second signal having the second frequency using the heating circuit 26 when the current state corresponds to the target state. For example, when the target state is determined based on the current temperature of the heater 18, the controller 12 may determine the current temperature of the heater 18 as the current state while the first signal is supplied to the heater 18. The controller 12 may determine whether the current temperature of the heater 18 corresponds to the target temperature. The controller 12 may generate the second signal having the second frequency using the heating circuit 26 when the current temperature of the heater 18 corresponds to the target temperature.

Examples of the target state and the method of determining the target state are not limited to the described embodiment.

In one embodiment, the second frequency may have a value less than or equal to the first frequency. When the frequency of the AC signal supplied to the circuit is lowered, the total impedance value of the circuit may be lowered as the reactance value occurring by the heater 18 is reduced.

In one embodiment, the controller 12 may supply the second signal to the heater 18. When the second signal having the second frequency is supplied to the heater 18, the total impedance of the circuit forming the heater 18 may be determined as a second impedance value.

In one embodiment, when the target state is determined based on the current temperature of the heater 18, the controller 12 may determine the current temperature of the heater 18 as the current state while the first signal is supplied to the heater 18. The controller 12 may determine whether the current temperature of the heater 18 corresponds to the target temperature. The controller 12 may generate the second signal having the second frequency using the heating circuit 26 when the current temperature of the heater 18 corresponds to the target temperature.

FIG. 7 is a flowchart illustrating a method of controlling an aerosol-generating device according to an embodiment.

Operations 710 to 750 to be described below may be performed by an aerosol-generating device (e.g., the aerosol-generating device 1 of FIGS. 1 and 2) or a controller (e.g., the controller 12 of FIGS. 1, 2, and 6) of the aerosol-generating device. The aerosol-generating device may include a heater assembly (e.g., the heater assembly 3 of FIGS. 2 to 5B), a heating circuit (e.g., the heating circuit 26 of FIGS. 2 or 6), and a controller.

In operation 710, the controller of the aerosol-generating device may generate a first signal having a first frequency using the heating circuit. For example, the first frequency may be greater than or equal to 100 KHz.

In operation 720, the controller of the aerosol-generating device may supply the first signal to the heater.

In operation 730, the controller of the aerosol-generating device may determine a current state of the aerosol-generating device.

In operation 740, the controller of the aerosol-generating device may generate a second signal having a second frequency using the heating circuit when the current state corresponds to a target state. For example, the second frequency may be less than or equal to the first frequency.

In operation 750, the controller of the aerosol-generating device may supply the second signal to the heater.

According to one embodiment, the operation of controlling the temperature of the heater 18 based on a heating profile may include operations 710 to 750. For example, the controller of the aerosol-generating device may control the temperature of the heater 18 based on the heating profile, and operations 710 to 750 may be performed while controlling the temperature of the heater 18.

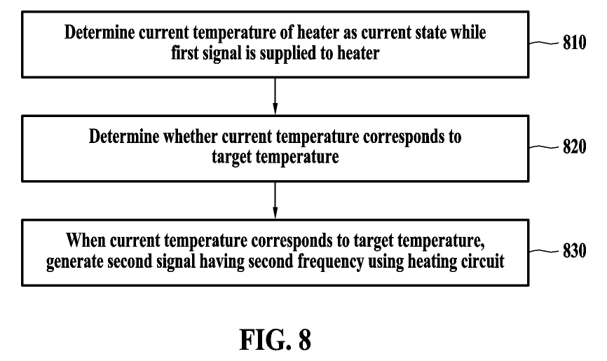

FIG. 8 is a flowchart illustrating a method of controlling an aerosol-generating device based on a current temperature of a heater according to an embodiment.

Operations 810 to 830 to be described below may be performed by an aerosol-generating device (e.g., the aerosol-generating device 1 of FIGS. 1 and 2) or a controller (e.g., the controller 12 of FIGS. 1, 2, and 6) of the aerosol-generating device. The aerosol-generating device may include a heater assembly (e.g., the heater assembly 3 of FIGS. 2 to 5B), a heating circuit (e.g., the heating circuit 26 of FIGS. 2 or 6), and a controller. For example, operation 810 may be performed after operation 720 described above with reference to FIG. 7 is performed. For example, operation 830 is performed, and then, operation 750 described above with reference to FIG. 7 may be performed.

In one embodiment, operation 730 described above with reference to FIG. 7 may include operation 810. In operation 810, the controller of the aerosol-generating device may determine the current temperature of the heater as the current state while the first signal is supplied to the heater.

In one embodiment, operation 740 described above with reference to FIG. 7 may include operations 820 and 830. In operation 820, the controller of the aerosol-generating device may determine whether the current temperature corresponds to the target temperature.

In operation 830, the controller of the aerosol-generating device may generate a second signal having a second frequency using the heating circuit when the current temperature corresponds to a target temperature.

According to one embodiment, an aerosol-generating device may include a heater assembly including a heater disposed around at least a portion of a cigarette inserted into the aerosol-generating device, a heating circuit connected to the heater, and a processor configured to control a signal supplied to the heater through the heating circuit, wherein the processor may be configured to generate a first signal having a first frequency using the heating circuit, supply the first signal to the heater, determine a current state of the aerosol-generating device, generate a second signal having a second frequency using the heating circuit when the current state corresponds to a target state, and supply the second signal to the heater.

According to one embodiment, the first frequency may be greater than or equal to 100 KHz.

According to one embodiment, the second frequency may be less than or equal to the first frequency.

According to one embodiment, the target state may be a state in which a timer associated with the first signal has expired.

According to one embodiment, the target state may be a state in which a current temperature of the heater corresponds to a target temperature.

According to one embodiment, the processor may be configured to determine a current temperature of the heater as the current state while the first signal is supplied to the heater, determine whether the current temperature corresponds to a target temperature, and when the current temperature corresponds to the target temperature, generate the second signal having the second frequency using the heating circuit.

According to one embodiment, the heater assembly may further include a first support member, when the heater has a cylindrical shape, coupled to an upper portion of the cylinder shape, and a second support member coupled to a lower portion of the cylinder shape.

According to one embodiment, the heater assembly may further include a vacuum member connecting the first support member and the second support member to surround at least a portion of the heater.

According to one embodiment, the heater assembly may further include a support member having a cylindrical cavity, and the heater may be disposed inside the cavity.

According to one embodiment, the heater assembly may further include a vacuum member surrounding at least a portion of the support member.

According to one embodiment, the heater may have a serpentine shape.

According to one embodiment, a method of controlling an aerosol-generating device performed by the aerosol-generating device, wherein the aerosol-generating device may include a heater assembly including a heater disposed around at least a portion of a cigarette inserted into the aerosol-generating device, a heating circuit connected to the heater, and a processor configured to control a signal supplied to the heater through the heating circuit, and the method may include generating a first signal having a first frequency using the heating circuit, supplying the first signal to the heater, determining a current state of the aerosol-generating device, generating a second signal having a second frequency using the heating circuit when the current state corresponds to a target state, and supplying the second signal to the heater.

According to one embodiment, the determining of the current state of the aerosol-generating device may include determining a current temperature of the heater as the current state while the first signal is supplied to the heater, and the generating of the second signal having the second frequency using the heating circuit when the current state corresponds to the target state may include determining whether the current temperature corresponds to a target temperature, and when the current temperature corresponds to the target temperature, generating the second signal having the second frequency using the heating circuit.

According to one embodiment, the first frequency may be greater than or equal to 100 KHz, and the second frequency may be less than or equal to the first frequency.

Certain embodiments or other embodiments of the disclosure described above are not mutually exclusive or distinct from each other. Any or all elements of the embodiments of the disclosure described above may be combined with another or combined with each other in configuration or function.

For example, a configuration "A" described in one embodiment of the disclosure and the drawings and a configuration "B" described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An aerosol-generating device comprising:
a heater assembly comprising a heater disposed around at least a portion of a cigarette inserted into the aerosol-generating device;
a heating circuit connected to the heater; and
a processor configured to control a signal supplied to the heater through the heating circuit, wherein the processor is configured to:
generate a first signal having a first frequency using the heating circuit; supply the first signal to the heater;
determine a current state of the aerosol-generating device;
generate a second signal having a second frequency using the heating circuit when the current state corresponds to a target state; and supply the second signal to the heater.

2. The aerosol-generating device of claim 1,
wherein the first frequency is greater than or equal to 100 kilohertz (KHz).

3. The aerosol-generating device of claim 1, wherein the second frequency is less than or equal to the first frequency.

4. The aerosol-generating device of claim 1, wherein the target state is a state in which a timer associated with the first signal has expired.

5. The aerosol-generating device of claim 1, wherein the target state is a state in which a current temperature of the heater corresponds to a target temperature.

6. The aerosol-generating device of claim 1, wherein the processor is configured to:
determine a current temperature of the heater as the current state while the first signal is supplied to the heater;
determine whether the current temperature corresponds to a target temperature; and
when the current temperature corresponds to the target temperature, generate the second signal having the second frequency using the heating circuit.

7. The aerosol-generating device of claim 1, wherein the heater assembly further comprises:
a first support member, when the heater has a cylindrical shape, coupled to an upper portion of the cylinder shape; and
a second support member coupled to a lower portion of the cylinder shape.

8. The aerosol-generating device of claim 7, wherein the heater assembly further comprises a vacuum member connecting the first support member and the second support member to surround at least a portion of the heater.

9. The aerosol-generating device of claim 1, wherein
the heater assembly further comprises a support member having a cylindrical cavity, and
the heater is disposed inside the cavity.

10. The aerosol-generating device of claim 9, wherein the heater assembly further comprises a vacuum member surrounding at least a portion of the support member.

11. The aerosol-generating device of claim 1, wherein the heater has a serpentine shape.

12. A method of controlling an aerosol-generating device performed by the aerosol-generating device,
wherein the aerosol-generating device comprises:
a heater assembly comprising a heater disposed around at least a portion of a cigarette inserted into the aerosol-generating device;
a heating circuit connected to the heater; and
a processor configured to control a signal supplied to the heater through the heating circuit, and
wherein the method comprises:
generating a first signal having a first frequency using the heating circuit;
supplying the first signal to the heater;
determining a current state of the aerosol-generating device;
generating a second signal having a second frequency using the heating circuit when the current state corresponds to a target state; and
supplying the second signal to the heater.

13. The method of claim 12, wherein
the determining of the current state of the aerosol-generating device comprises determining a current temperature of the heater as the current state while the first signal is supplied to the heater, and
the generating of the second signal having the second frequency using the heating circuit when the current state corresponds to the target state comprises:
determining whether the current temperature corresponds to a target temperature; and
when the current temperature corresponds to the target temperature, generating the second signal having the second frequency using the heating circuit.

14. The method of claim 12, wherein
the first frequency is greater than or equal to 100 kilohertz (KHz), and
the second frequency is less than or equal to the first frequency.

15. A non-transitory computer-readable storage medium storing instructions that, when executed by a processor, cause the processor to perform the method of claim 12.
